(19) United States
(12) Patent Application Publication
(10) Pub. No.: US 2009/0052189 A1
(43) Pub. Date: Feb. 26, 2009

(54) LED SPOTLIGHT

(75) Inventor: Shusaku KON, Shinagawa-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC LIGHTING, LTD., Tokyo (JP)

(21) Appl. No.: 12/048,817

(22) Filed: Mar. 14, 2008

(30) Foreign Application Priority Data
Mar. 19, 2007 (JP) 2007-070521

(51) Int. Cl. F21V 13/02; F21K 7/00; F21V 7/00

(52) U.S. Cl. 362/296.01; 362/311.02; 362/231

(57) ABSTRACT

An LED spotlight includes: a light source unit including an RGB-LED light source composed of R, G and B LEDs, and a condenser lens for condensing light beams of mixed color projected from the RGB-LED light source on an entrance end face of a rod lens; a pyramid rod lens whose cross-sectional area converges from an entrance end face to an exit end face; and a reflector for condensing rays of exiting light exiting as a point light source from the exit face of the pyramid rod lens on an axial line of the pyramid rod lens. A light beam incident on the pyramid rod lens progresses while repeatedly internally reflected several times, thereby brightness irregularity at the exit end of the rod lens is lowered, and color mixture is accelerated, so that a light beam is emitted as a point light source of white light whose color is observed as the same color, seen from any direction, and the light beams are condensed as a spotlight on the axial line of the pyramid rod lens by the reflector.

This application is based upon and claims the benefit of priority from Japanese patent application No. 2007-070521, filed on Mar. 19, 2007, the disclosure of which is incorporated herein in its entirety by reference.

### BACKGROUND OF THE INVENTION

1. Field of the Invention

The present invention relates to an LED spotlight having an LED as a light source, particularly to an LED spotlight including a rod lens.

2. Description of the Related Art

An LED (light-emitting diode) has features such as low power consumption, long service life, low heat generation, quick response, and space saving. Accordingly, LED have been widely used in illumination applications in which an LED is used as a light source and LED have found practice use in applications from a traffic lights to a headlights of automobiles.

On the one hand, light from an LED has a characteristic in which the light intensity changes depending on a light exit angle. Accordingly, it is difficult to control light distribution by using a reflector, as compared to using compared to the case of an electric bulb. Further, because light from an LED has a high directivity and a sharp spectrum, the light is difficult to mix due to the nature of the LED. Due to the nature, in the case of a white color LED light using R, G and B LEDs, a different color is seen depending on the viewing angle when colors are insufficiently mixed.

Further, as a related art of the present invention, there is a white light source in which a blue light emitting element is encapsulated with material such as a transparent binder containing fluorescent material, and light emitted from yellow, fluorescent material excited by incoming blue light is mixed with the incoming blue light to emit white light. Also in this case, color irregularity is generated depending on how an object is illuminated with light from an LED.

Japanese Patent Laid-Open No. 2003-262795 discloses, to address such a problem, an illumination system that uses a solid state light source and that is capable of outputting light that has a uniform light intensity distribution due to using a simple structure that is realized through the use of a rod lens. Also, Japanese Patent Laid-Open No. 2004-212469 discloses an illumination system in which a plurality of LED lamps is used, and these light beams are input to a rod lens to provide uniform exiting light having a high light intensity. Further, Japanese Patent Laid-Open No. 2004-226509 discloses a stroboscopic device for irradiating light widely, using an LED as a light source.

LEDs have found a widening application range in which an LED is used for illumination, but there has not been disclosed a case example where an LED is used for a spotlight to solve the above described problems.

The invention in Japanese Patent Laid-Open No. 2003-262795 is directed to illuminate a light bulb in a projector, and exiting light from a rod lens is adjusted by a cylindrical lens to fit an aspect ratio of the light bulb.

The invention in Japanese Patent Laid-Open No. 2004-212469 discloses that a plurality of LED lamps is used, and light beams are input to a rod integrator, which provides uniform exiting light having a high light intensity, but does not state formation of a spot light.

In the invention in Japanese Patent Laid-Open No. 2004-226509, an LED is used, and light is widely irradiated by using a reflector, a diffusion plate and a concave lens.

However, none of the documents state that irradiated light is collected into a spotlight.

### SUMMARY OF THE INVENTION

An object of the present invention is to provide a spotlight having a white color without any color irregularity, based on light from an LED source.

An LED spotlight of the present invention includes a light source using an LED, a rod lens for emitting a uniform light beam from an exit end face after making an incoming light beam from an entrance end face uniform, a first light condensing means for condensing rays of exiting light from the light source on the entrance end face of the rod lens, and a second light condensing means for condensing rays of exiting light from the rod lens.

The rod lens may be a rod lens of a quadrangular pyramid type whose cross-sectional area converges from an entrance end face to an exit end face.

Further, the rod lens may be a rod lens of a quadratic prism type whose entire length is fifteen times or more of the length of a side of the entrance end face.

Also, the light source using an LED may be a light source in which R, G and B LEDs are integrally formed, and the first light condensing means may be a lens for condensing rays of exiting light from the integrated R, G and B LEDs on the entrance end face of the rod lens.

Further, the light source using an LED may be a light source in which R, G and B LEDs are separately provided, and the first light condensing means may include a lens for condensing each ray of exiting light from the separate R, G and B LEDs, a cross dichroic mirror lens for collecting respective rays of exiting light from the lens on the entrance end face of the rod lens, and a lens for condensing rays of exiting light from the cross dichroic mirror lens on the entrance end face of the rod lens.

Also, the light source using an LED may be a white light source in which a blue LED is encapsulated with a transparent binder containing fluorescent material, and the first light condensing means may be a lens for condensing rays of exiting light from the white light source on the entrance end face of the rod lens.

The second light condensing means may be a reflector, or a lens.

According to the present invention, passing light through the rod lens including an exit end having a small area can provide a point light source formed of a complete diffusion light, and it becomes easy to design a spotlight.

Also, according to the present invention, even when LEDs of three colors, R, G and B are used, light from an LED is used as an exciting light, and even when white light is obtained from fluorescent material, light is passed through the rod lens, thereby color irregularity can be reduced.

The present invention uses a configuration in which a light from an LED is collected at one point by the light condensing means, and at a position where the focal point is formed, the rod lens is installed, and ahead of the rod lens including the exit end having a small area, the reflector or the lens is provided to condense a light. According to this configuration, the invention laid open in this application can provide the point light source formed of a complete diffusion light, and can sufficiently mix colors, therefore there is an advantage in which a spotlight of white light without color irregularity is provided.

### BRIEF DESCRIPTION OF THE DRAWINGS

FIG. 1 is a schematic side view of an LED spotlight of a first exemplary embodiment of the present invention;

FIG. 2 is a schematic side view of an LED spotlight of a second exemplary embodiment of the present invention;

FIG. 3 is a schematic side view of an LED spotlight of a third exemplary embodiment of the present invention; and

FIG. 4 is a schematic side view of an LED spotlight of a fourth exemplary embodiment of the present invention.

### DETAILED DESCRIPTION OF THE PREFERRED EMBODIMENT(S)

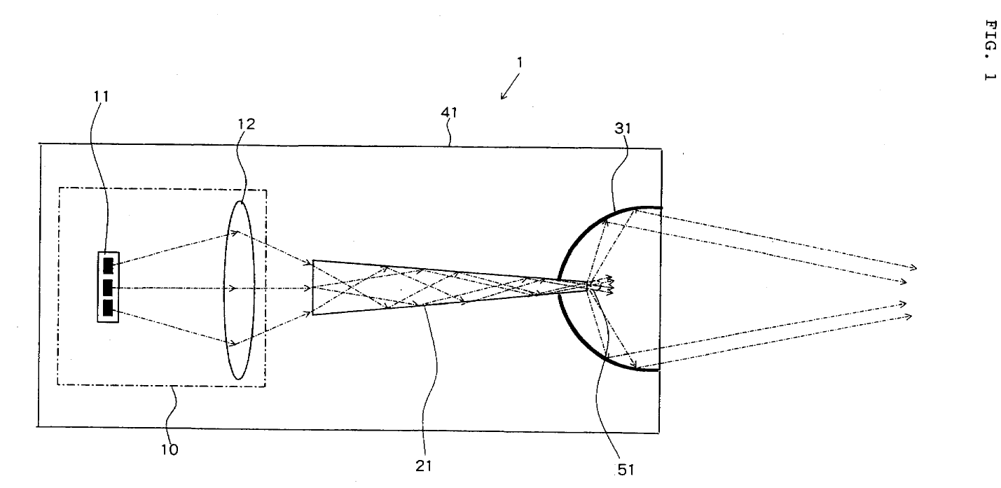

Next, a first exemplary embodiment of the present invention will be described with reference to the accompanying drawings. FIG. 1 is a schematic side view of an LED spotlight of the first exemplary embodiment of the present invention.

LED spotlight 1 of the first exemplary embodiment of the present invention includes RGB-LED light source 11, light source unit 10, pyramid rod lens 21, reflector 31, and casing 41.

Light source unit 10 has first condenser lens 12. First condenser lens 12 is a first light condensing means for condensing light beams of mixed color projected from RGB-LED light source 11 on an entrance face of rod lens 21. Pyramid rod lens 21 is a pyramid-shaped lens whose cross-section converges toward an exit face. Reflector 31 condenses rays of exiting light exiting from the exit face of pyramid rod lens 21 to form point light source 51. Here, the first light condensing means has been described as a condenser lens, but a reflector may be used.

Electric current is supplied to RGB-LED light source 11 from a power supply not shown via a switch.

A circumferential wall of pyramid rod lens 21 is a reflecting surface, and a light beam incident on pyramid rod lens 21 progresses while being repeatedly internally reflected several times. Accordingly, brightness irregularity at the exit end of pyramid rod lens 21 is lowered, and a light beam exits from the narrow exit end as point light source 51.

As described above, light from an LED has a high directivity and a sharp spectrum, and the light is difficult to mix because of the nature of the LED. Due to the nature, there is a problem that, in the case of a white color LED light using R, G and B LEDs, a different color is seen depending on a viewing angle when colors are insufficiently mixed.

However, passing a light beam through pyramid rod lens 21 accelerates color mixture, so that intensity of a light of each color exiting from the LED does not concentrate locally. As the result, a light beam incident on pyramid rod lens 21 is emitted from pyramid rod lens 21 as white light whose color is observed as the same color, seen from any direction.

The light exiting from pyramid rod lens 21 as point light source 51 is condensed as a spotlight in an axial direction of pyramid rod lens 21 by reflector 31 that is a second light condensing means.

In the first exemplary embodiment, the light source has been described as RGB-LED light source 11 composed of R, G and B LEDs, but the present invention is not limited to this.

The present invention can be also applied to white light source in which a blue light emitting element is encapsulated with a transparent binder containing yellow, fluorescent material, and a blue light emitted from the blue light emitting element and light emitted from the fluorescent material excited by incoming blue light are mixed with each other to emit white light. Also in this case, color irregularity generated due to the way that light from an LED irradiates can be lowered at the exit end by passing the light through rod lens 21.

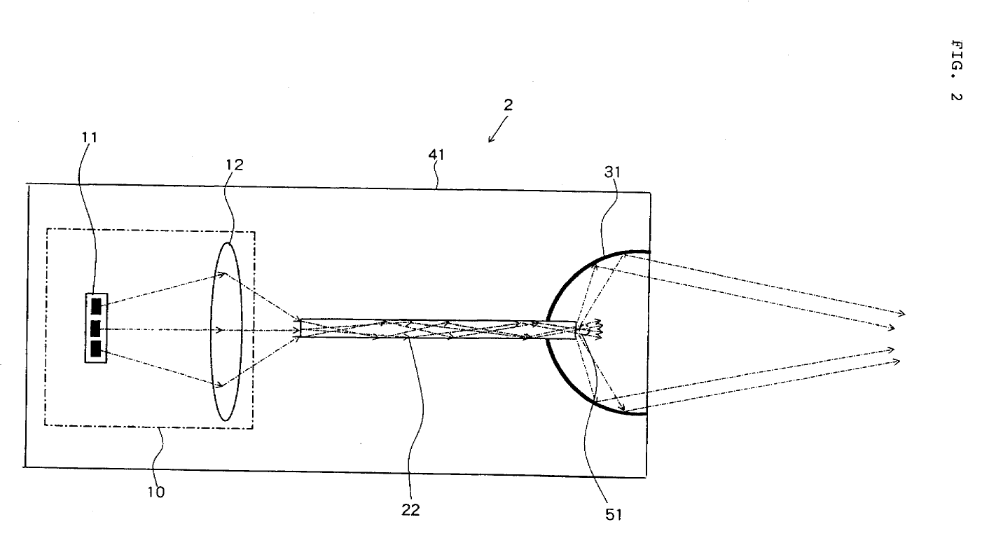

Next, a second exemplary embodiment of the present invention will be described with reference to the accompanying drawings. FIG. 2 is a schematic side view of an LED spotlight of the second exemplary embodiment of the present invention.

LED spotlight 2 of the second exemplary embodiment has the same structure and function as the first exemplary embodiment, except that pyramid rod lens 21 is changed to elongated, square rod lens 22 whose entire length is fifteen times or more of the length of a side of an entrance end face. Then, in the following description, a like component is denoted by a like symbol, and the description will be omitted.

In the second exemplary embodiment, a light beam incident on an entrance end of square rod lens 22 through condenser lens 12 progresses while repeatedly being reflected several times inside elongated, square rod lens 22. Accordingly, brightness irregularity at an exit end of square rod lens 22 is lowered, and a light beam exits from a narrow exit end as point light source 51.

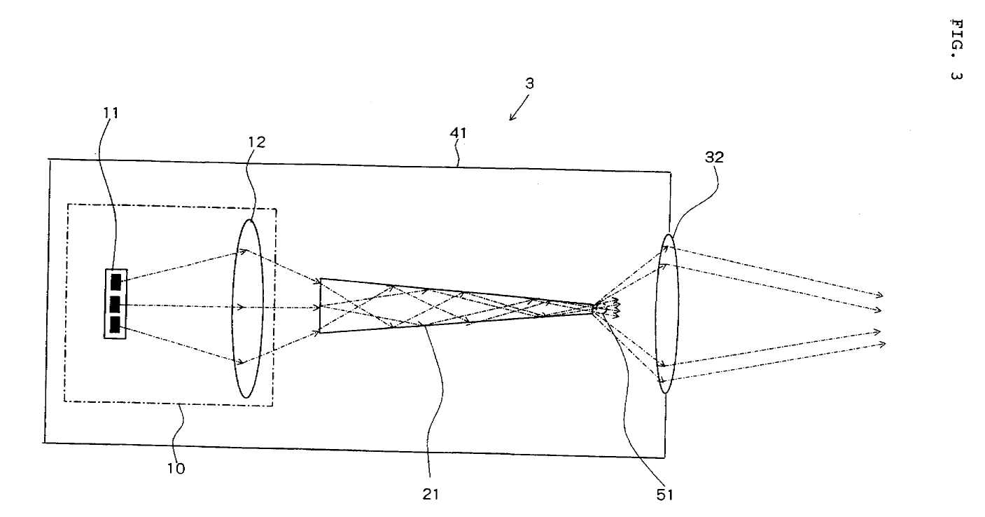

Next, a third exemplary embodiment of the present invention will be described with reference to the accompanying drawings. FIG. 3 is a schematic side view of an LED spotlight of the third exemplary embodiment of the present invention.

LED spotlight 3 of the third exemplary embodiment has the same structure and function as the first exemplary embodiment, except that the second light condensing means is changed from reflector 31 to second condenser lens 32, then a like component is denoted by a like symbol, and the description will be omitted.

In the third exemplary embodiment, rays of exiting light exit from the exit face of pyramid rod lens 21 as point light source 51 are condensed as a spotlight in an axial direction of pyramid rod lens 21 by second condenser lens 32. In this case, a moveable structure of second condenser lens 32 in the axial direction of the lens may be used to move the focusing position of second condenser lens 32. Here, pyramid rod lens 21 may be square rod lens 22 of the second exemplary embodiment.

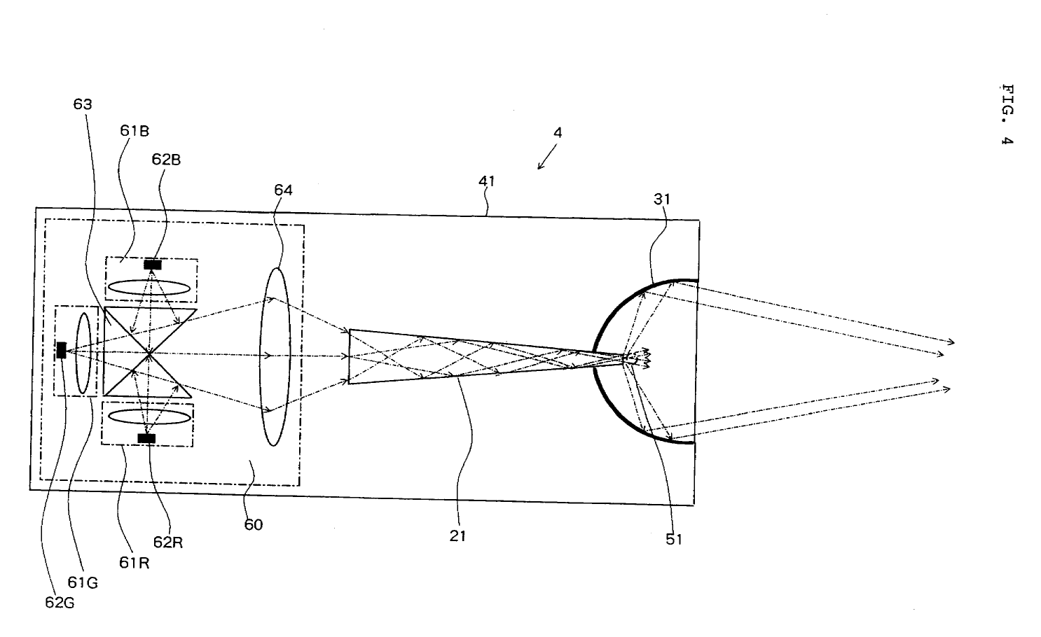

Next, a fourth exemplary embodiment of the present invention will be described with reference to the accompanying drawings. FIG. 4 is a schematic side view of an LED spotlight of the fourth exemplary embodiment of the present invention.

In LED spotlight 4 of the fourth exemplary embodiment, light source unit 10 of the first exemplary embodiment is changed to light source unit 60.

Light source unit 60 comprises a combination of R (red), G (green), and B (blue) light source units 61R, 61G and 61B, which emit light in three directions, respectively, cross dichroic mirror 63 for collecting rays of exiting light from each of the light source units in one direction, and condenser lens 64.

For other components, the present exemplary embodiment has the same structure and function as the first exemplary embodiment, and a like component is denoted by a like symbol, and the description will be omitted.

R (red) light source unit 61R, G (green) light source unit 61G, and B (blue) light source unit 61B include R-LED light source 62R, G-LED light source 62G, and B-LED light source 62B, respectively, and a lens. Green light, blue light and red light, each exiting from each light source is condensed by its own lens to enter an entrance face of cross dichroic mirror 63. These incident light beams are collected to enter condenser lens 64 from an exit face, and then enter the entrance face of pyramid rod lens 21.

In FIG. 4, a description has been provided referring to the example where light source unit 10 of the first exemplary embodiment in FIG. 1 is changed to light source unit 60, but light source unit 10 in the second and third exemplary embodiments may be changed to light source unit 60.

In the fourth exemplary embodiment, the light source unit is divided into an individual unit of R, G and B, so that the output power of the LED can be increased to enhance illuminance of the point light source.

In each exemplary embodiment described above, the rod lens has been described as the pyramid type or the elongated, square rod type, but a transparent, conical shape type or cylindrical column type may also be used.

What is claimed is:

1. An LED spotlight, comprising:
a light source using an LED,
a rod lens for emitting a uniform light beam from an exit end face after uniforming an incoming light beam from an entrance end face,
a first light condensing means for condensing rays of exiting light from the light source on the entrance end face of the rod lens, and
a second light condensing means for condensing rays of exiting light from the rod lens.

2. The LED spotlight according to claim 1, wherein
the rod lens is a rod lens of a quadrangular pyramid type whose cross-sectional area converges from the entrance end face to the exit end face.

3. The LED spotlight according to claim 1, wherein
the rod lens is a rod lens of a quadratic prism type whose entire length is fifteen times or more of the length of a side of the entrance end face.

4. The LED spotlight according to claim 1, wherein
the light source using an LED is a light source in which R, G and B LEDs are integrally formed, and
the first light condensing means is a lens for condensing rays of exiting light from the integrated R, G and B LEDs on the entrance end face of the rod lens.

5. The LED spotlight according to claim 1, wherein
the light source using an LED is a light source in which R, G and B LEDs are separately provided, and
the first light condensing means includes: a lens for condensing each ray of exiting light from the separate R, G and B LEDs; a cross dichroic mirror lens for collecting respective rays of exiting light from the lens toward on the entrance end face of the rod lens; and a lens for condensing rays of exiting light from the cross dichroic mirror lens on the entrance end face of the rod lens.

6. The LED spotlight according to claim 1, wherein
the light source using an LED is a white light source in which a blue LED is encapsulated with a transparent binder containing fluorescent material, and
the first light condensing means is a lens for condensing rays of exiting light from the white light source on the entrance end face of the rod lens.

7. The LED spotlight according to claim 1, wherein
the second light condensing means is a reflector.

8. The LED spotlight according to claim 1, wherein
the second light condensing means is a lens.
